(19) United States
(12) Patent Application Publication
(10) Pub. No.: US 2026/0305603 A1
(43) Pub. Date: Oct. 8, 2026

(54) SYSTEMS AND METHODS FOR TISSUE CROSSLINKING

(71) Applicant: Krishna Kupumbati, Irvine, CA (US)

(72) Inventor: Krishna Kupumbati, Irvine, CA (US)

(21) Appl. No.: 19/252,422

(22) Filed: Jun. 27, 2025

Related U.S. Application Data
(60) Provisional application No. 63/783,553, filed on Apr. 4, 2025.

(51) Int. Cl. A01N 1/142; A01N 1/128

(52) U.S. Cl. CPC A01N 1/142; A01N 1/128

(57) ABSTRACT

Described herein are systems and methods for tissue crosslinking that enhance biomechanical integrity and reduce post-implantation complications. Unlike conventional approaches that rely on prolonged external exposure of tissue to crosslinking agents, the disclosed techniques utilize a controlled, “inside-out” crosslinking strategy. A microneedle or similar delivery device penetrates the tissue to deliver a crosslinking agent directly to the interior, allowing crosslinking to proceed outwardly. The penetration depth can be selected based on the thickness of the tissue, and the quantity, concentration, and composition of the crosslinking agent can be precisely controlled. This approach avoids the application of a crosslinking agent externally, better preserves tissue elasticity and strength, and reduces the risk of shrinkage and the need for revision procedures following implantation.

### CROSS-REFERENCE TO RELATED APPLICATIONS

This application is a non-provisional and claims benefit of U.S. Provisional Application No. 63/783,553 filed Apr. 4, 2025, the specification of which is incorporated herein in their entirety by reference.

### FIELD OF THE INVENTION

The present invention features devices, systems, and methods for crosslinking tissue samples.

### BACKGROUND OF THE INVENTION

Glutaraldehyde, a widely used crosslinking agent, is known to exist predominantly in complex polymeric forms, with only a minimal fraction present as reactive monomers. Despite their low abundance, monomeric glutaraldehyde species play a significant role in effective crosslinking and long-term stabilization of biological tissues. Accordingly, although the process is cost-prohibitive, efforts have been made in certain contexts to purify and utilize monomeric glutaraldehyde for crosslinking applications. However, preserving glutaraldehyde in its monomeric form remains challenging, as its stability is highly dependent on various factors, including pH, temperature, and storage conditions.

In conventional tissue preservation protocols, biological tissue is soaked in a glutaraldehyde solution. A limitation of this method is that polymeric glutaraldehyde tends to accumulate at the tissue surface, forming a barrier that prevents or delays the diffusion of monomeric species into deeper layers. As a result, extended soaking periods are often required to ensure uniform crosslinking throughout the tissue, particularly at its core. This prolonged exposure can lead to undesirable outcomes, including excessive tissue stiffness, reduced elasticity, and the presence of residual, unbound glutaraldehyde. The final preserved tissue is therefore often mechanically rigid and retains residual glutaraldehyde, which may pose toxicity concerns.

Accordingly, the present invention provides devices configured to deliver a minimal effective concentration of a crosslinking agent (e.g., glutaraldehyde) directly to the center of the tissue, allowing it to diffuse outward—thereby enabling controlled, inside-out crosslinking. This approach facilitates more uniform crosslinking while minimizing surface polymerization and associated drawbacks. As a result, the devices described herein enhance the elasticity of the treated tissue while significantly reducing or eliminating residual toxicity.

Therefore, the present invention features devices designed to inject the lowest concentration of a crosslinking agent (e.g., glutaraldehyde) in the center and let it diffuse to the outside (i.e., inside-out crosslinking using the right amount of glutaraldehyde). The devices described herein increase the elasticity of the cross-linked tissue with minimal or no toxicity.

### BRIEF SUMMARY OF THE INVENTION

It is an objective of the present invention to provide systems, devices, and methods that allow for the crosslinking of a tissue sample, as specified in the independent claims. Embodiments of the invention are given in the dependent claims. Embodiments of the present invention can be freely combined with each other if they are not mutually exclusive.

Bovine pericardial tissue patches on the market are susceptible to several deficiencies: calcification, poor handling, suture line bleeding, delamination, etc. due to lack of sufficient elasticity. This leads to complications for the patients after patches are implanted such as shrinkage and need for repeat surgery. The other devices (e.g., other pericardial tissue patches on the market) are susceptible to increased rates of infection and shrink after implantation. Thus, the present invention features devices and methods for tissue patch crosslinking that increase the elasticity of the patch, which can withstand the pulsatile motion of cardiac and vascular grafts. The increased elasticity will enable the patch to withstand constant pulsating movements of the heart and vasculature. This reduces the patch shrinkage and other problems mentioned above. This leads to better outcomes for the patient and increased cost savings for the hospital. The result of the current invention enhances the mechanical strength of the tissue while maintaining its superior flexibility, soft, and supple characteristics.

In some embodiments, the present invention provides a tissue fixation device comprising a substrate with a first surface and a second surface, at least one channel (e.g., a first channel) fluidly connected to the substrate and configured to convey a fluid therethrough, and an injection component fluidly connected to the channel. The channel (e.g., the first channel) may include a first end fluidly connected to the substrate and a second end fluidly connected to an injection component, such as a syringe or pump, which delivers fluid into the channel. In some embodiments, the channel (e.g., the first channel) may further include a flow control valve to regulate the delivery of fluid, e.g., into the substrate. In certain embodiments, a second channel is also provided, similarly configured and fluidly connected. For example, the second channel may be fluidly connected to the substrate and configured to convey a fluid therethrough. The second channel may include a first end fluidly connected to the substrate and a second end fluidly connected to an injection component. A reservoir may be fluidly connected to the injection component to supply the desired fluid. The fluid may include a crosslinking agent, such as glutaraldehyde, or other agents, including decellularizing agents, drying agents, or flushing agents. In such embodiments where a reservoir is included in the device, it may be fluidly connected to the second channel (e.g., at the second end of the second channel) and to the injection component. Alternatively, the reservoir may be fluidly connected to the first channel (e.g., at the second end of the first channel) and the injection component. The substrate may be a hollow structure or a hollow grid-like structure comprising an internal cavity. Alternatively, the substrate may also include a plurality of parallel, hollow channels, each with its own internal cavity, allowing for the uniform distribution of fluid across the substrate. A plurality of hollow microprotrusions—such as microneedles, microtubes, or nanotubes—may be disposed on or within the substrate. In some embodiments, the microprotrusions are initially located within an internal cavity of the substrate and when the injection component delivers fluid through the channel into the internal cavity of the substrate, the resulting fluid pressure forces the hollow microprotrusions to extend through the and opening in the first surface of the substrate, causing the microprotrusions to project outward from the surface. In some embodiments, the microprotrusions may be atraumatic.

Alternatively, in some embodiments, the tissue fixation device comprises a substrate comprising a first surface and a second surface, a first channel fluidly connected to the substrate (e.g., the first end is fluidly connected to the substrate), comprising a first end and a second end, and configured to convey a fluid therethrough, an injection component fluidly connected to the second end of the first channel and configured to inject the fluid into the first channel, and a second channel configured to convey a fluid therethrough, comprising a first end fluidly connected to the substrate and a second end fluidly connected to the injection component. In some embodiments, the device further comprises a reservoir fluidly connected to both the injection component and the second channel (see FIG. 2A). In other embodiments, the device further comprises a reservoir fluidly connected to both the injection component and the first channel (see FIG. 2C). In some embodiments, the first surface of the substrate comprises a plurality of hollow microprotrusions extending therefrom. In other embodiments, the substrate comprises a plurality of hollow microprotrusions disposed within the internal cavity of the substrate.

One of the unique and inventive technical features of the present invention is the use of an “inside-out” crosslinking approach, wherein a tissue sample is crosslinked from the interior toward the exterior. Without wishing to limit the invention to any theory or mechanism, it is believed that the crosslinking strategy described herein advantageously enhances the elasticity and mechanical strength of the treated tissue. Additionally, the present invention enables the use of an optimal amount of crosslinking agent, which is determined by the number of free amine groups available in the collagen. Since only a small fraction of these amine groups are free, only a minimal amount of crosslinking agent is required—typically in the nanomolar to micromolar range. None of the presently known prior references or works have the unique inventive technical feature of the present invention.

Moreover, the prior art references teach away from the present invention. For example, conventional tissue crosslinking methods often involve soaking a tissue sample in a crosslinking solution, such as 0.6% glutaraldehyde, for extended periods—typically 15 to 30 days. These approaches frequently result in reduced elasticity and stiff tissue, which can lead to post-implantation complications such as tissue shrinkage and an increased likelihood of requiring revision surgeries.

Furthermore, the inventive technical feature of the present invention contributed to a surprising result. For example, as little as 0.01% of the crosslinking agent was sufficient to achieve complete tissue crosslinking within 24 hours or less.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings, in which:

FIGS. 1A, 1B, 1C, and 1D show one embodiment of the tissue fixation devices described herein. Specifically, FIG. 1A shows a tissue fixation device comprising a pump as the injection component, whereas FIG. 1B shows a syringe as the injection component. FIGS. 1C and 1D shows the top view of the tissue fixation device.

FIGS. 2A, 2B, and 2C show an alternative embodiment of the tissue fixation devices described herein.

FIG. 3 shows a tissue sample being sandwiched between two tissue fixation devices.

FIGS. 4A, 4B, 4C, and 4D show an embodiment of the tissue fixation device in which the substrate is inserted through the middle of the tissue sample.

FIGS. 5A and 5B show a non-traumatic microneedle used with the devices described herein.

FIG. 6 shows a non-limiting example of a method that may be used.

FIGS. 7A, 7B, 7C, and 7D show tensile strength, percent elongation, suture retention, and calcification potential, respectively, of bovine pericardial tissue after crosslinking using the methods described herein and prior art methods such as soaking for 15 days in 0.6% glutaraldehyde.

### DETAILED DESCRIPTION OF THE INVENTION

Following is a list of elements corresponding to a particular element referred to herein:
100 Tissue Fixation Device
110 Substrate
111 First Surface
112 Second Surface
115 Internal Cavity
120 Microprotrusions
125 Opening
130 Channel
131 First End
132 Second End
135 Flow Control Valve
140 Injection Component
150 Reservoir
200 Tissue Sample

Unless otherwise explained, all technical and scientific terms used herein have the same meaning as commonly understood by one of ordinary skill in the art to which a disclosed invention belongs. The singular terms “a,” “an,” and “the” include plural referents unless context clearly indicates otherwise. Similarly, the word “or” is intended to include “and” unless the context clearly indicates otherwise. The term “comprising” means that other elements can also be present in addition to the defined elements presented. The use of “comprising” indicates inclusion rather than limitation. Stated another way, the term “comprising” means “including principally, but not necessary solely”. Furthermore, variation of the word “comprising”, such as “comprise” and “comprises”, have correspondingly the same meanings. In one respect, the technology described herein related to the herein described compositions, methods, and respective component(s) thereof, as essential to the invention, yet open to the inclusion of unspecified elements, essential or not (“comprising”).

All publications, patent applications, patents, and other references mentioned herein are incorporated by reference in their entirety for all purposes. In case of conflict, the present specification, including explanations of terms, will control.

Although methods and materials similar or equivalent to those described herein can be used to practice or test the disclosed technology, suitable methods and materials are described below. The materials, methods, and examples are illustrative only and not intended to be limiting.

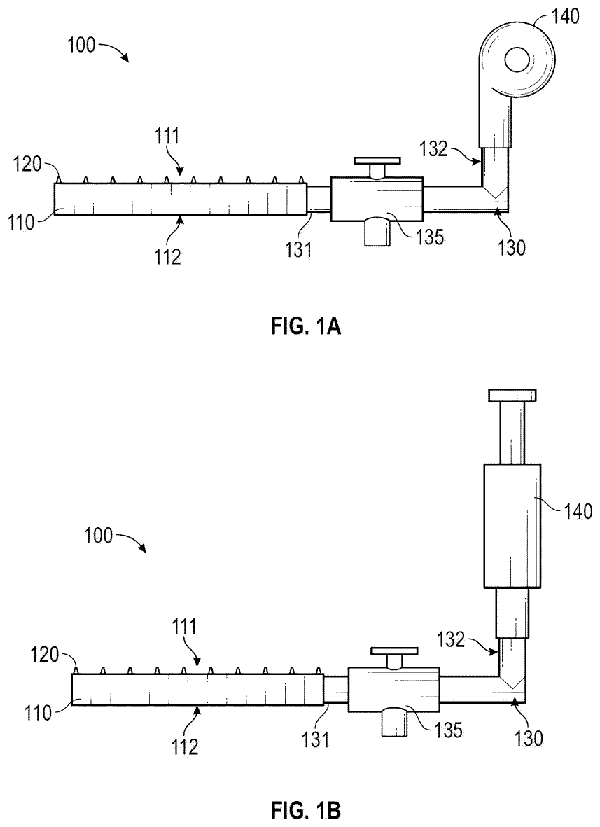

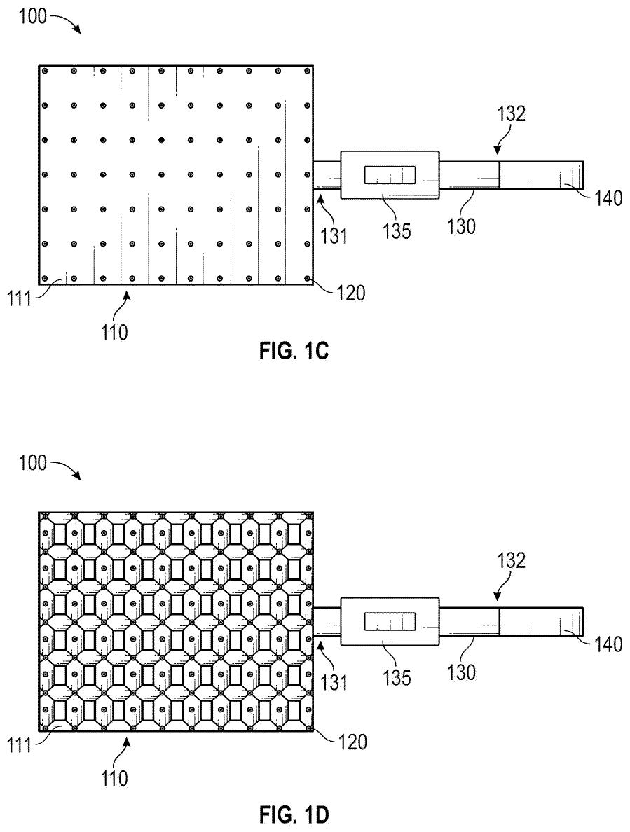

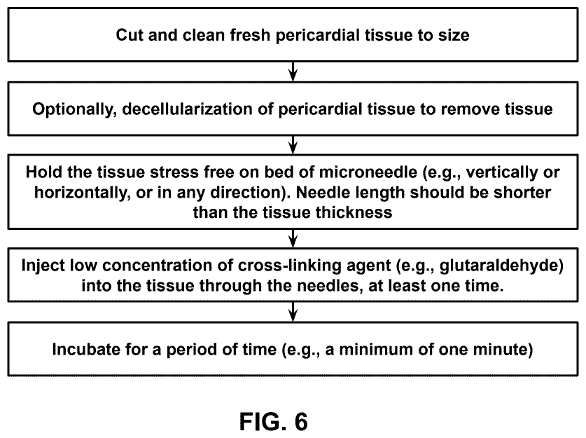

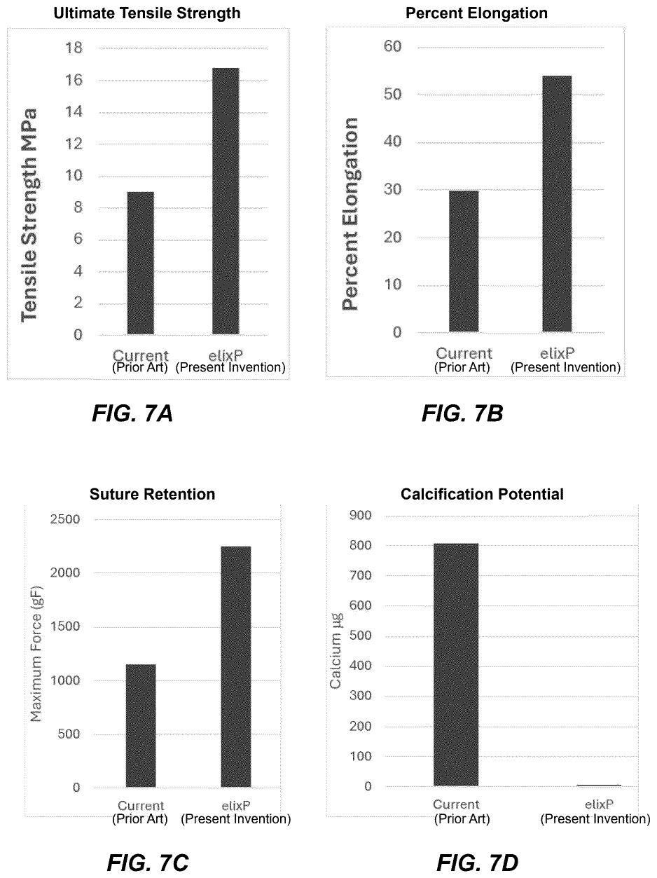

Referring now to FIGS. 1A-7D, the present invention provides a novel tissue crosslinking technology, including devices and methods for controlled crosslinking initiated from the interior of the tissue outward. In certain embodiments, the tissue is stabilized without the application of external pressure. A crosslinking agent is delivered to the central region of the tissue using a microneedle or similar penetrating structure capable of reaching the tissue core. The length or penetration depth of the delivery device may be selected based on the thickness of the target tissue. Additionally, the composition, concentration, and volume of the crosslinking agent may be precisely controlled to optimize fixation outcomes.

### Tissue Fixation Devices

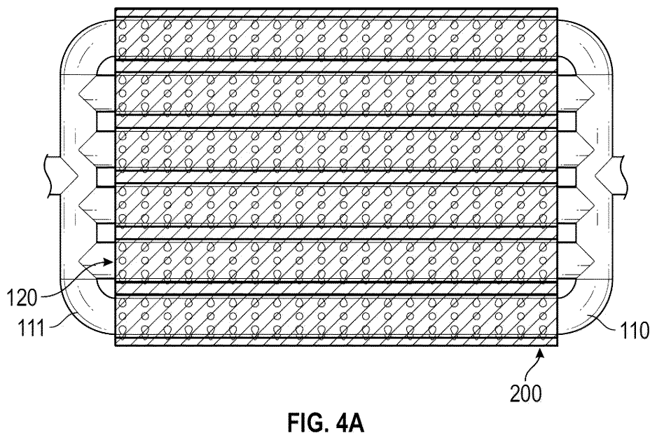

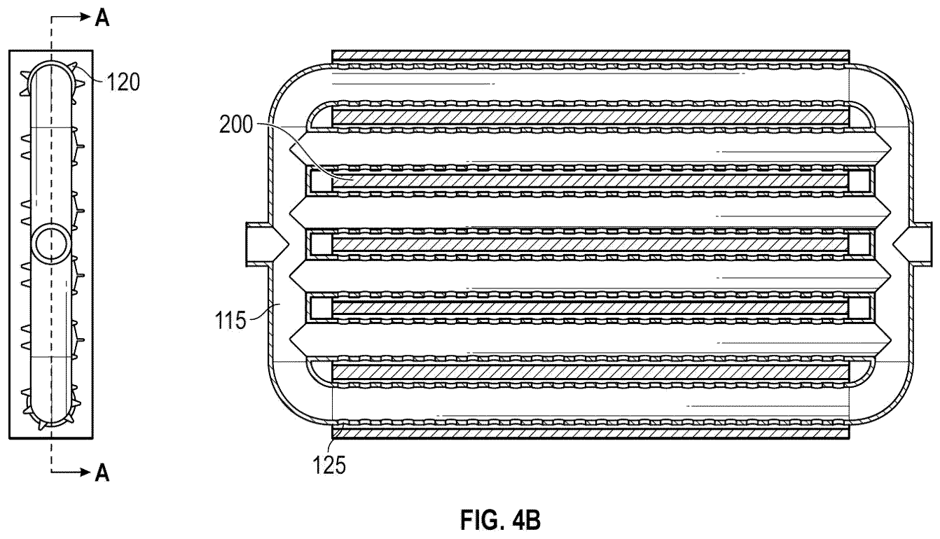

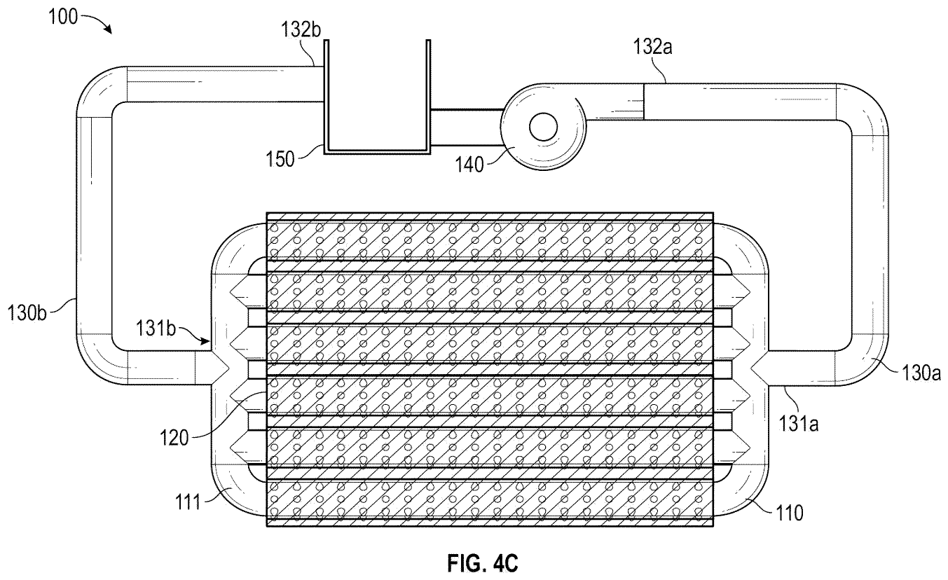

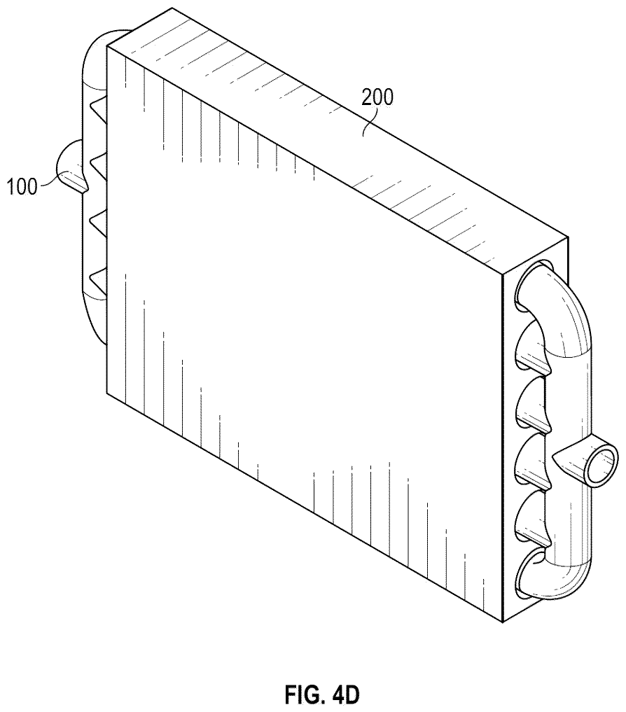

In some embodiments, the present invention features devices comprising microneedles, microtubes, or nanotubes that can penetrate only to the extent needed and capable of injecting crosslinking agents (FIGS. 1A-1D, 2A-2C, and FIG. 3). In other embodiments, the present invention features fine tubes that can penetrate throughout the tissue (FIGS. 4A-4D).

Different configurations of the devices described herein with protrusions (e.g., microneedles, microtubes, or nanotubes) are described below. In some embodiments, the tissue sample can be placed on top of a bed of needles or sandwiched, i.e., between two beds of needles. Similarly, in some embodiments, a network of tubes may be inserted into the tissue, and a crosslinking agent can be injected to the center of the tissue.

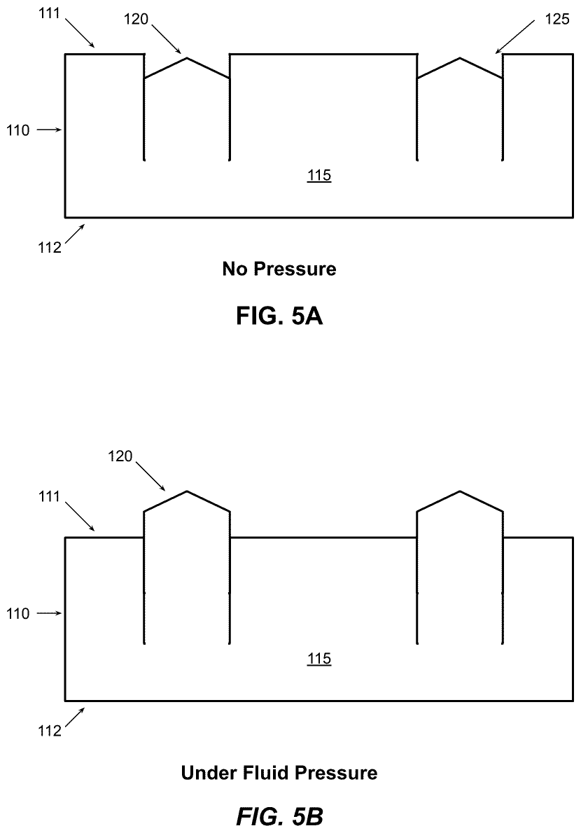

Referring to FIGS. 1A-1D, the present invention features a tissue fixation device (100). In some embodiments, the tissue fixation device (100) comprises a substrate (110) comprising a first surface (111) and a second surface (112), a channel (130) comprising a first end (131) and a second end (132) fluidly connected to the substrate (e.g., the first end (131) is fluidly connected to the substrate (110)) and configured to convey a fluid therethrough, and an injection component (140) fluidly connected to the second end (132) of the channel (130) and configured to inject the fluid into the channel (130). In some embodiments, the injection component (140) is configured to inject the fluid through the channel (130) and into an internal cavity (115) of the substrate (110). In some embodiments, the channel (130) further comprises a flow control valve (135) disposed between the first end (131) and the second end (132) of the channel (130). In some embodiments, the first surface (111) of the substrate (110) comprises a plurality of hollow microprotrusions (120) extending therefrom. In other embodiments, the substrate (110) comprises a plurality of hollow microprotrusions (120) disposed within the internal cavity (115) of the substrate (110; see FIGS. 5A-5B). In some embodiments, when the hollow microprotrusions (120) are disposed within the internal cavity (115) of the substrate (110), the tip (e.g., peak) of each microprotrusion is aligned (e.g., flush) with the first surface (111) of the substrate (110). In such embodiments, when the injection component (140) delivers fluid through the channel (130) into the internal cavity (115) of the substrate (110), the resulting fluid pressure forces the hollow microprotrusions (120) to extend through the first surface (111) of the substrate (110), causing the microprotrusions (120) to project outward from the surface.

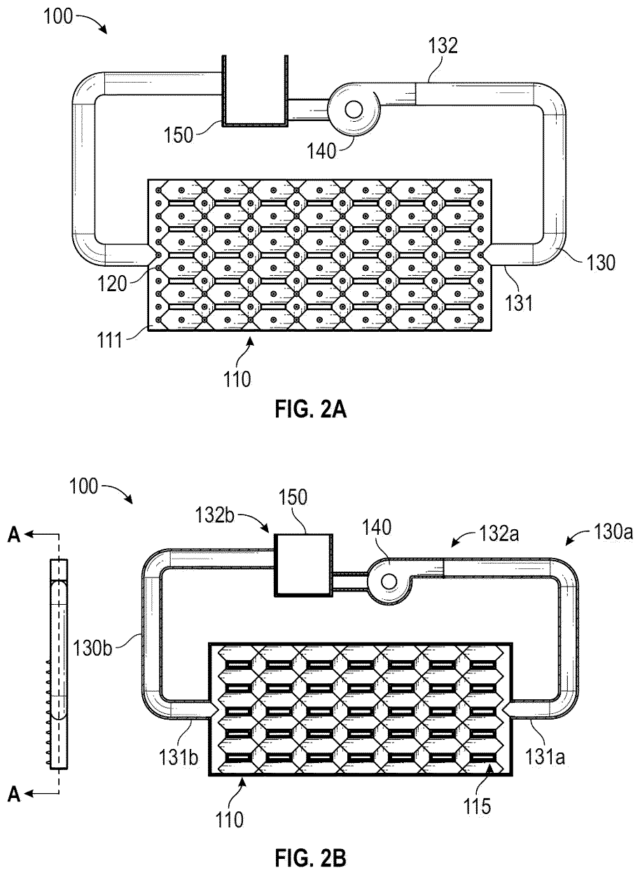

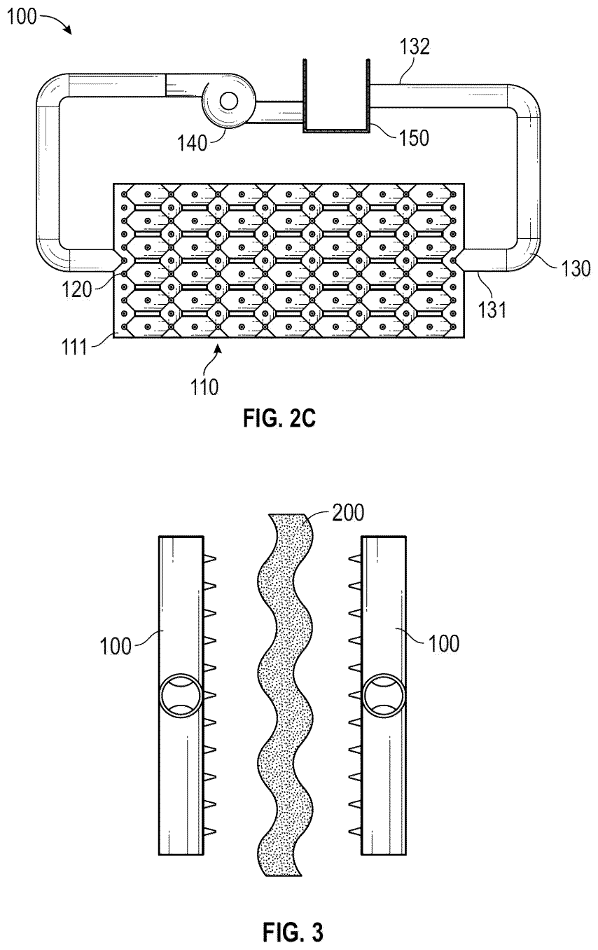

Referring to FIGS. 2A-2C, the present invention may also feature a looped tissue fixation system, e.g., a tissue fixation device (100) that enables continuous or recirculating flow of a fluid. In some embodiments, the tissue fixation device (100) comprises a substrate (110) comprising a first surface (111) and a second surface (112), a first channel (130a) fluidly connected to the substrate (110) and configured to convey a fluid therethrough comprising a first end (131a) and a second end (132a), an injection component (140) fluidly connected to the second end (132a) of the first channel (130a) and configured to inject the fluid into the first channel (130a), and a second channel (130b) fluidly connected to the substrate (110) and configured to convey a fluid therethrough comprising a first end (131b) and a second end (132b). In some embodiments, the first end (131a) of the first channel (130a) is fluidly connected to the substrate (110), and the second end (132a) of the first channel (132a) is fluidly connected to the injection component (140). In some embodiments, the first end (131b) of the second channel (130b) is fluidly connected to the substrate (110), and the second end (132b) is fluidly connected to the injection component (140). In some embodiments, the first surface (111) of the substrate (110) comprises a plurality of hollow microprotrusions (120) extending therefrom. In other embodiments, the substrate (110) comprises a plurality of hollow microprotrusions (120) disposed within the internal cavity (115) of the substrate (110; see FIGS. 5A-5B). In some embodiments, when the hollow microprotrusions (120) are disposed within the internal cavity (115) of the substrate (110), the tip (e.g., peak) of each microprotrusion is aligned (e.g., flush) with the first surface (111) of the substrate (110). In such embodiments, when the injection component (140) delivers fluid through the channel (130) into the internal cavity (115) of the substrate (110), the resulting fluid pressure forces the hollow microprotrusions (120) to extend through the and opening (125) in the first surface (111) of the substrate (110), causing the microprotrusions (120) to project outward from the surface. In certain embodiments, the tissue fixation device (100) further comprises a reservoir (150) that is fluidly connected to the injection component (140) and the second channel (130b), e.g., reservoir (150) is fluidly connected to the second end (132b) or the second channel (130b) and the injection component (140). Alternatively, the tissue fixation device (100) further comprises a reservoir (150) that is fluidly connected to the injection component (140) and the first channel (130a), such as the second end (132b) of the first channel (130a).

Referring to FIG. 3, in some embodiments, two tissue fixation devices (100) described above may be used in combination to securely sandwich a tissue sample between them (i.e., two separate tissue fixation devices (100) may be used together to sandwich the tissue sample between them). Without wishing to limit the present invention to any theory or mechanism, it is believed that his configuration helps ensure uniform exposure of the tissue to the crosslinking agent from both sides, promoting more consistent fixation throughout the sample.

Referring to FIG. 4A-4D, the present invention may further feature a tissue fixation device (100) that is inserted through the tissue sample. In some embodiments, the tissue fixation device (100) comprises a substrate (110) comprising a plurality of parallel channels, a first channel (130b) fluidly connected to the substrate (110) and configured to convey a fluid therethrough, and an injection component (140) fluidly connected to the first channel (130a) and configured to inject the fluid into the first channel (130a), and a second channel (130b) fluidly connected to the substrate (110) and the second end (132b) is fluidly connected to the injection component (140). In some embodiments, the first end (131a) of the first channel (130a) is fluidly connected to the substrate (110), and the second end (132a) of the first channel (130a) is fluidly connected to the injection component (140). In some embodiments, the first end (131b) of the second channel (130b) is fluidly connected to the substrate (110), and the second end (132b) of the second channel (130b) is connected to the injection component (140). In some embodiments, each channel of the substrate (110) comprises a plurality of hollow microprotrusions (120) extending therefrom. For example, in some embodiments, the plurality of hollow microprotrusions (120) is disposed circumferentially around each channel of the substrate (110). In other embodiments, the substrate (110) comprises a plurality of hollow microprotrusions (120) disposed within the internal cavity (115) of the substrate (110; see FIGS. 5A-5B). In some embodiments, when the hollow microprotrusions (120) are disposed within the internal cavity (115) of the substrate (110), the tip (e.g., peak) of each microprotrusion is aligned (e.g., flush) with the first surface (111) of the substrate (110). In such embodiments, when the injection component (140) delivers fluid through the channel (130) into the internal cavity (115) of the substrate (110), the resulting fluid pressure forces the hollow microprotrusions (120) to extend through the and opening (125) in the first surface (111) of the substrate (110), causing the microprotrusions (120) to project outward from the surface. In certain embodiments, the tissue fixation device (100) further comprises a reservoir (150) that is fluidly connected to the injection component (140) and the second channel (130b), e.g., reservoir (150) is fluidly connected to the second end (132b) or the second channel (130b) and the injection component (140). Alternatively, the tissue fixation device (100) further comprises a reservoir (150) that is fluidly connected to the injection component (140) and the first channel (130a), such as the second end (132b) of the first channel (130a).

In some embodiments, the microprotrusions (120) are microneedles, microtubes, nanotubes, or a combination thereof. For example, the hollow microprotrusions (120) are hollow microneedles, hollow microtubes, hollow nanotubes, or a combination thereof.

In some embodiments, the injection component (140) is a syringe. In other embodiments, the injection component (140) is a pump.

In some embodiments, the substrate (110) is a hollow substrate comprising an inner cavity (115). In other embodiments, the substrate (100) is a hollow grid-like structure comprising an inner cavity (115). In certain embodiments, the substrate (100) comprises a plurality of parallel channels; wherein each of the parallel channels is hollow and comprises an inner cavity (115).

In some embodiments, the substrate (100) comprises at least one microprotrusion per square centimeter. In some embodiments, the substrate (100) comprises at least one microprotrusion per square millimeter. In some embodiments, the substrate (100) comprises at least one microprotrusion per square micrometer. In some embodiments, the substrate (100) comprises at least one microprotrusion per square nanometer.

In some embodiments, the height of the microprotrusions can be adjusted based on the thickness of the tissue. As a general guideline, the microprotrusions should penetrate at least half the thickness of the tissue when applied from one side. For example, if the tissue is 2 mm thick, the microprotrusions may be approximately 1 mm in height. In embodiments where the tissue is sandwiched between two devices, each set of microprotrusions may penetrate approximately one-quarter of the tissue thickness from opposite sides.

The present invention also features methods for tissue fixation using the devices described herein. In some embodiments, the method includes placing a tissue sample onto the substrate (110) of a tissue fixation device (100) and injecting a fluid—such as a crosslinking agent—into the channel (130) via the injection component (140) for a defined period of time. The method may further comprise positioning a second tissue fixation device (100) on the opposite side of the tissue sample, such that the sample is sandwiched between the first and second substrates (110) (see FIG. 3).

In alternative embodiments, the method includes inserting a substrate (110)—for example, a substrate comprising a plurality of channels (130)—through the tissue sample. In some embodiments, the substrate (110) includes a plurality of hollow microprotrusions (120) extending from its first surface (111), which puncture the tissue and enable the delivery of fluid directly into the tissue sample. In other embodiments, the microprotrusions (120) are initially disposed within an internal cavity (115) of the substrate (110). When fluid is injected into the substrate (110) through the channel (130) via the injection component (140), the resulting fluid pressure forces the microprotrusions (120) to extend through the first surface (111) and into the tissue. This pressure-induced deployment allows the microprotrusions (120) to penetrate the tissue in an atraumatic manner.

The aforementioned methods may further include incubating the tissue sample for a period of time following the injection of the fluid to allow for full fixation. The methods described herein are applicable to a range of tissue types and fixation agents depending on the intended use.

In some embodiments, the tissue sample is a bovine pericardial tissue sample. In other embodiments, the tissue may be pericardial tissue of other origin, including human or non-bovine animal sources. The tissue sample is not limited to pericardial tissue, however. The present invention may be applied to any type of animal or human tissue requiring crosslinking or fixation.

In some embodiments, the crosslinking agent is glutaraldehyde. Non-limiting examples of crosslinking agents that may be used with the devices described herein include, but are not limited to, glutaraldehyde, formaldehyde, paraformaldehyde, genipin, carbodiimides (e.g., EDC/NHS), glyceraldehyde, and diisocyanates (e.g., hexamethylene diisocyanate).

In some embodiments, the amount of crosslinking agent may vary depending on the tissue. One of ordinary skill in the art would understand that effective crosslinking depends on the number of free amine groups available in the collagen matrix. Because only a small fraction of amine groups are free, only minimal amounts of crosslinking agent—typically in the nanomolar to micromolar range—are needed. For example, in the case of glutaraldehyde, crosslinking occurs through Schiff base formation between the aldehyde groups of the glutaraldehyde and the free amine groups in the tissue. A minimum 1:1 molar ratio of aldehyde to free amine groups is generally required for efficient crosslinking.

In some embodiments, the crosslinking agent has a concentration of about 0.001% to about 0.5%. In some embodiments, the crosslinking agent has a concentration of about 0.001% to about 0.25%. In some embodiments, the crosslinking agent has a concentration of about 0.001% to about 0.1%. In some embodiments, the crosslinking agent has a concentration of about 0.001% to about 0.05%. In some embodiments, the crosslinking agent has a concentration of about 0.001% to about 0.025%. In some embodiments, the crosslinking agent has a concentration of about 0.001% to about 0.01%.

In some embodiments, the crosslinking agent has a concentration of about 1% to about 10%. In some embodiments, the crosslinking agent has a concentration of about 1% to about 5%. In some embodiments, the crosslinking agent has a concentration of about 1% to about 4%. In some embodiments, the crosslinking agent has a concentration of about 1% to about 3%. In some embodiments, the crosslinking agent has a concentration of about 1% to about 2.5%. In some embodiments, the crosslinking agent has a concentration of about 1% to about 2%. In some embodiments, the crosslinking agent has a concentration of about 2% to about 10%, or about 2% to about 5%, or about 2% to about 4%, or about 2% to about 3%, or about 2% to about 2.5%. In some embodiments, the crosslinking agent has a concentration of about 3% to about 10%, or about 3% to about 5%, or about 3% to about 3%. In some embodiments, the crosslinking agent has a concentration of about 4% to about 10%, or about 4% to about 5%. In some embodiments, the crosslinking agent has a concentration of about 5% to about 10%.

In some embodiments, the tissue sample may first be injected with a crosslinking agent—or other chemical agents—for a defined period of time, followed by an incubation period to allow the agent to interact with the tissue. In other embodiments, the agent may be continuously injected or circulated through the tissue to enhance penetration and ensure uniform treatment

In some embodiments, the fluid (e.g., the crosslinking agent) is injected into the tissue sample for at least a minute. In some embodiments, the fluid (e.g., the crosslinking agent) is injected into the tissue sample for at least five minutes. In some embodiments, the fluid (e.g., the crosslinking agent) is injected into the tissue sample for at least ten minutes. In some embodiments, the fluid (e.g., the crosslinking agent) is injected into the tissue sample for at least 20 minutes. The present invention is not limited to the aforementioned injection times and may include any suitable duration depending on factors such as the type, size, or thickness of the tissue sample, as well as the intended use or application. Alternatively, the sample may be subjected to continuous injection of the fluid (e.g., the crosslinking agent) to achieve the desired effect.

In some embodiments, the tissue sample is incubated with the fluid (e.g., the crosslinking agent) for at least about 24 hours. In some embodiments, the tissue sample is incubated with the fluid (e.g., the crosslinking agent) for at least about 18 hours. In some embodiments, the tissue sample is incubated with the fluid (e.g., the crosslinking agent) for at least about 12 hours. In some embodiments, the tissue sample is incubated with the fluid (e.g., the crosslinking agent) for at least about 6 hours. In some embodiments, the tissue sample is incubated with the the fluid (e.g., the crosslinking agent) for about 12 hours to about 72 hours, or about 12 hours to about 60 hours, or about 12 hours to about 48 hours, or about 12 hours to about 36 hours, or about 12 hours to about 24 hours. The present invention is not limited to the incubation times described above. In certain embodiments, the tissue sample is incubated with the fluid (e.g., the crosslinking agent) agent for at least 24 hours, although longer or shorter durations may be used depending on the desired outcome.

Without wishing to limit the present invention to any theories or mechanisms, it is believed that the methods described herein (i.e., the “inside-out” method) allow for more efficient control of crosslinking by adjusting the concentration and exposure time of the crosslinking agent. For example, at higher concentrations, the crosslinking agent may be injected into the tissue sample for a shorter duration and requires less time to remain in contact with the tissue to achieve complete crosslinking. Alternatively, when using a lower concentration, the agent may be injected into the tissue over an extended period and/or the tissue may be left in contact with the agent for a longer duration to achieve comparable crosslinking.

In some embodiments, the tissue sample is crosslinked at a temperature of about 10° C. In some embodiments, the tissue sample is crosslinked at a temperature of about 20° C. In some embodiments, the tissue sample is crosslinked at a temperature of about 30° C. In some embodiments, the tissue sample is crosslinked at a temperature of about 40° C. In some embodiments, the tissue sample is crosslinked at a temperature of about 50° C. In certain embodiments, the tissue sample is crosslinked at a temperature of less than about 55° C. In some embodiments, the tissue sample is crosslinked at a temperature of about 10° C. to about 55° C., or about 10° C. to about 50° C., or about 10° C. to about 40° C., or about 10° C. to about 30° C., or about 10° C. to about 20° C. Again, the present invention is not limited to the aforementioned temperatures; other temperatures, including those up to 55° C., may be used in accordance with the methods disclosed herein. Without wishing to limit the present invention to any theory or mechanism, it is believed that lower temperatures increase the time required to achieve complete crosslinking, whereas higher temperatures reduce the crosslinking time.

One of ordinary skill in the art will recognize that the methodologies described herein are also applicable to processes where chemical-induced toxicity or concentration-dependent material property changes are a concern. For example, the invention may be used to inject decellularizing agents to process tissue, drying agents to remove moisture, or flushing agents to remove excess or unreacted materials such as crosslinking agents, decellularizing agents, or drying agents. Alternatively, the sample may be flushed with saline to remove tissue fluids.

Non-limiting examples of decellularizing agents include, but are not limited to, detergents such as Tween, Triton, and SDS, as well as water. Drying agents may include alcohols, glycerol, or other dehydrating compounds. For flushing steps, suitable agents include saline, air, or other inert fluids.

Additionally, the devices herein may be used for sequential chemical injections to facilitate in situ chemical reactions within the tissue. For instance, a first chemical (e.g., reagent A) may be injected to react with specific groups in the tissue, followed by a flush to remove any unreacted reagent, and then a second chemical (e.g., reagent B) may be introduced to react with the remaining functionalized tissue. Any unreacted chemical can again be flushed out following the reaction.

### EXAMPLE

The following is a non-limiting example of the present invention. It is to be understood that said example is not intended to limit the present invention in any way. Equivalents or substitutes are within the scope of the present invention.
Conventional Fixation Procedure: Tissue samples were fixed using a 0.6% glutaraldehyde solution for a total of 15 days at room temperature. During the fixation period, the glutaraldehyde solution was changed 3 to 8 times to maintain reactivity and reduce the accumulation of free aldehydes.
ElixP Fixation Procedure (Present Invention): Tissue samples were fixed using a 0.01% glutaraldehyde solution for 24 to 48 hours at room temperature. No solution changes were performed during the fixation period.

As used herein, the term “about” refers to plus or minus 10% of the referenced number.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

Reference numbers recited herein, in the drawings, and in the claims are solely for ease of examination of this patent application and are exemplary. The reference numbers are not intended in any way to limit the scope of the claims to the particular features having the corresponding reference numbers in the drawings.

What is claimed is:

1. A device (100) comprising:
a) a substrate (110) comprising a first surface (111) and a second surface (112);
b) a channel (130) configured to convey a fluid therethrough comprising a first end (131) and a second end (132); wherein the first end (131) is fluidly connected to the substrate (110), and
c) an injection component (140) fluidly connected to the second end (132) of the channel (130) and configured to inject the fluid into the channel (130).

2. The device (100) of claim 1, further comprising a second channel (130b) configured to convey a fluid therethrough comprising a first end (131b) and a second end (132b); wherein the first end (131b) is fluidly connected to the substrate (110) and the second end (132b) is fluidly connected to the injection component (140).

3. The device (100) of claim 2, further comprising a reservoir (150) fluidly connected to the injection component (140) and the second end (132b) of the second channel (130).

4. The device (100) of claim 1, wherein the fluid comprises a crosslinking agent, decellularizing agent, drying agent, or flushing agent.

5. The device (100) of claim 2, wherein the crosslinking agent is glutaraldehyde.

6. The device (100) of claim 1, wherein the first surface (111) of the substrate (110) comprises a plurality of hollow microprotrusions (120) extending therefrom.

7. The device (100) of claim 1, wherein the substrate (110) comprises a plurality of hollow microprotrusions (120) disposed within an internal cavity (115) of the substrate (110).

8. The device (100) of claim 5, wherein when the injection component (140) delivers fluid through the channel (130) into the internal cavity (115) of the substrate (110), the resulting fluid pressure forces the hollow microprotrusions (120) to extend through the first surface (111) of the substrate (110), causing the microprotrusions (120) to extend outward from the surface.

9. The device (100) of claim 1, wherein the microprotrusions are microneedles, microtubes, nanotubes, or a combination thereof.

10. The device (100) of claim 7, wherein the microtubes are atraumatic.

11. The device (100) of claim 1, wherein the channel (130) further comprises a flow control valve (135) disposed between the first end (131) and the second end (132) of the channel (130).

12. The device (100) of claim 1, wherein the injection component (140) is a syringe or a pump.

13. The device (100) of claim 1, wherein the substrate (110) is a hollow substrate comprising an inner cavity (115).

14. The device of claim 1, wherein the substrate (100) is a hollow grid-like structure comprising an inner cavity (115).

15. The device of claim 1, wherein the substrate (100) comprises a plurality of parallel channels; wherein each of the parallel channels is hollow and comprises an inner cavity (115).

16. A device (100) comprising:
a) a substrate (110) comprising a plurality of parallel channels,
b) a first channel (130a) configured to convey a fluid therethrough comprising a first end (131a) and a second end (132a); wherein the first end (131a) is fluidly connected to the substrate (110),
c) an injection component (140) fluidly connected to the second end (132a) of the first channel (130a) and configured to inject the fluid into the first channel (130a); and
d) a second channel (130b) configured to convey a fluid therethrough comprising a first end (131b) and a second end (132b); wherein the first end (131b) is fluidly connected to the substrate (110) and the second end (132b) is fluidly connected to the injection component (140).

17. The device (100) of claim 16, further comprising a reservoir (150) fluidly connected to the injection component (140) and the second end (132b) of the second channel (130).

18. The device (100) of claim 16, wherein each channel of the substrate (110) comprises a plurality of hollow microprotrusions (120) extending therefrom; wherein the plurality of hollow microprotrusions (120) is disposed circumferentially around each channel of the substrate (110).

19. The device (100) of claim 16, wherein each channel of the substrate (110) comprises a plurality of hollow microprotrusions (120) disposed within an internal cavity (115) of the channel.

20. The device (100) of claim 19, wherein when the injection component (140) delivers fluid through the channel (130) into the internal cavity (115) of the substrate (110), the resulting fluid pressure forces the hollow microprotrusions (120) to extend through the first surface (111) of the substrate (110), causing the microprotrusions (120) to extend outward from the surface.
